(19) United States
(12) Patent Application Publication
(10) Pub. No.: US 2024/0365340 A1
(43) Pub. Date: Oct. 31, 2024

(54) METHOD FOR INFORMATION PROCESSING AND TERMINAL DEVICE

(71) Applicant: GUANGDONG OPPO MOBILE TELECOMMUNICATIONS CORP., LTD., Dongguan (CN)

(72) Inventor: Chuanfeng HE, Dongguan (CN)

(21) Appl. No.: 18/766,593

(22) Filed: Jul. 8, 2024

Related U.S. Application Data
(63) Continuation of application No. PCT/CN2022/071437, filed on Jan. 11, 2022.

(51) Int. Cl. H04W 72/232

(52) U.S. Cl. CPC H04W 72/232

(57) ABSTRACT

A method for information processing and a terminal device is provided. The method includes the following. A terminal device receives first information from a network device. The first information is used for determining a transform-precoder enabling state of a physical uplink shared channel (PUSCH).

### CROSS REFERENCE TO RELATED APPLICATION(S)

This application is a continuation of International Application No. PCT/CN2022/071437, filed Jan. 11, 2022, the entire disclosure of which is incorporated herein by reference.

### TECHNICAL FIELD

This disclosure relates to the field of communication, and more specifically to a method for information processing, a terminal device, a network device, a chip, a computer-readable storage medium, a computer program product, a computer program, and a communication system.

### BACKGROUND

In a communication system, the selection of an uplink (UL) waveform has an important influence on coverage. For example, a discrete fourier transform-spread orthogonal frequency division multiplexing (DFT-S-OFDM) waveform has a relatively low peak to average power ratio (PAPR), which can achieve better coverage and can be applied in scenarios with limited coverage. A cyclic prefix orthogonal frequency division multiplexing (CP-OFDM) waveform can support more flexible data scheduling, which may be often applied in scenarios with unlimited coverage. However, in the related art, a method for switching the UL waveform is not flexible enough, so that it is difficult to improve UL coverage.

### SUMMARY

In a first aspect, a method for information processing is provided in embodiments of the disclosure. The method includes the following. A terminal device receives first information from a network device. The first information is used for determining a transform-precoder enabling state of a physical uplink shared channel (PUSCH).

In a second aspect, a method for information processing is provided in embodiments of the disclosure. The method includes the following. A network device sends first information to a terminal device. The first information is used for determining a transform-precoder enabling state of a PUSCH.

In a third aspect, a terminal device is further provided in embodiments of the disclosure. The terminal device includes a processor and a memory. The memory is configured to store a computer program. The processor is configured to invoke and execute the computer program stored in the memory, to perform receive first information from a network device, wherein the first information is used for determining a transform-precoder enabling state of a PUSCH.

Other features and aspects of the disclosed features will become apparent from the following detailed description, taken in conjunction with the accompanying drawings, which illustrate, by way of example, the features in accordance with embodiments of the disclosure. The summary is not intended to limit the scope of any embodiments described herein.

### BRIEF DESCRIPTION OF THE DRAWINGS

FIG. 1 is a schematic architectural diagram of a communication system according to an embodiment of the disclosure.

FIG. 2 is a flowchart block diagram of a method for information processing according to an embodiment of the disclosure.

FIG. 3 is a flowchart block diagram of a method for information processing according to another embodiment of the disclosure.

FIG. 4 a schematic diagram of transmission time of a physical uplink shared channel (PUSCH) according to an embodiment of the disclosure.

FIG. 5 is a schematic diagram illustrating switching of a waveform according to an embodiment of the disclosure.

FIG. 6 is a schematic diagram of a type-2 configured grant (CG) resource configuration mode according to an embodiment of the disclosure.

FIG. 7 is a schematic structural block diagram of a terminal device according to an embodiment of the disclosure.

FIG. 8 is a schematic structural block diagram of a terminal device according to another embodiment of the disclosure.

FIG. 9 is a schematic structural block diagram of a network device according to an embodiment of the disclosure.

FIG. 10 is a schematic structural block diagram of a network device according to another embodiment of the disclosure.

FIG. 11 is a schematic block diagram of a communication device according to an embodiment of the disclosure.

FIG. 12 is a schematic block diagram of a chip according to an embodiment of the disclosure.

FIG. 13 is a schematic block diagram of a communication system according to an embodiment of the disclosure.

### DETAILED DESCRIPTION

The following will describe technical solutions of embodiments of the disclosure with reference to the accompanying drawings in embodiments of the disclosure.

The technical solutions of embodiments of the disclosure are applicable to various communication systems, for example, a global system of mobile communication (GSM), a code division multiple access (CDMA) system, a wideband code division multiple access (WCDMA) system, a general packet radio service (GPRS), a long term evolution (LTE) system, an advanced LTE (LTE-A) system, a new radio (NR) system, an evolved system of an NR system, an LTE-based access to unlicensed spectrum (LTE-U) system, an NR-based access to unlicensed spectrum (NR-U) system, a non-terrestrial network (NTN) system, a universal mobile telecommunication system (UMTS), a wireless local area network (WLAN), a wireless fidelity (WiFi), a 5th-generation (5G) communication system, or other communication systems, or the like.

Generally speaking, a conventional communication system supports a limited quantity of connections and therefore is easy to implement. However, with development of communication technology, a mobile communication system will not only support conventional communication but also support, for example, device to device (D2D) communication, machine to machine (M2M) communication, machine type communication (MTC), vehicle to vehicle (V2V) communication, or vehicle to everything (V2X) communication, or the like. Embodiments of the disclosure can also be applied to these communication systems.

In an embodiment, the communication system in embodiments of the disclosure may be applied to a carrier aggregation (CA) scenario, or may be applied to a dual connectivity (DC) scenario, or may be applied to a standalone (SA) network deployment scenario.

Various embodiments of the disclosure are described in connection with a network device and a terminal device. The terminal device may also be referred to as a user equipment (UE), an access terminal, a subscriber unit, a subscriber station, a mobile station, a remote station, a remote terminal, a mobile device, a user terminal, a terminal, a wireless communication device, a user agent, or a user device, or the like.

The terminal device may be a station (ST) in a WLAN, a cellular radio telephone, a cordless telephone, a session initiation protocol (SIP) telephone, a wireless local loop (WLL) station, a personal digital assistant (PDA), a handheld device or a computing device with wireless communication functions, other processing devices coupled with a wireless modem, an in-vehicle device, a wearable device, and a terminal device in a next-generation communication system, for example, a terminal device in an NR network, or a terminal device in a future evolved public land mobile network (PLMN), or the like.

In embodiments of the disclosure, the terminal device may be deployed on land, which includes indoor or outdoor, handheld, wearable, or in-vehicle. The terminal device may also be deployed on water (such as ships, etc.). The terminal device may also be deployed in the air (such as airplanes, balloons, satellites, etc.).

In embodiments of the disclosure, the terminal device may be a mobile phone, a pad, a computer with wireless transceiver functions, a virtual reality (VR) terminal device, an augmented reality (AR) terminal device, a wireless terminal device in industrial control, a wireless terminal device in self driving, a wireless terminal device in remote medicine, a wireless terminal device in smart grid, a wireless terminal device in transportation safety, a wireless terminal device in smart city, or a wireless terminal device in smart home, or the like.

By way of explanation rather than limitation, in embodiments of the disclosure, the terminal device may also be a wearable device. The wearable device may also be referred to as a wearable smart device, which is a generic term of wearable devices obtained through intelligentization design and development on daily wearing products with wearable technology, for example, glasses, gloves, watches, clothes, accessories, and shoes. The wearable device is a portable device that can be directly worn or integrated into clothes or accessories of a user. In addition to being a hardware device, the wearable device can also realize various functions through software support, data interaction, and cloud interaction. A wearable smart device in a broad sense includes, for example, a smart watch or smart glasses with complete functions and large sizes and capable of realizing independently all or part of functions of a smart phone, and for example, various types of smart bands and smart jewelries for physical monitoring, of which each is dedicated to application functions of a certain type and required to be used together with other devices such as a smart phone.

In embodiments of the disclosure, the network device may be a device, for example, an access-network device, configured to communicate with a mobile device. The network device may be an access point (AP) in a WLAN, a base transceiver station (BTS) in GSM or CDMA, or may be a Node B (NB) in WCDMA, or may be an evolutional Node B (eNB or eNodeB) in LTE, or a relay station or AP, or an in-vehicle device, a wearable device, a network device (gNB) in an NR network, a network device in a future evolved PLMN, or the like.

The network device may further be a core-network device, for example, a mobility management entity (MME), an access and mobility management function (AMF), and other network entities, and embodiments of the disclosure are not limited in this regard.

By way of explanation rather than limitation, in embodiments of the disclosure, the network device may be mobile. For example, the network device may be a mobile device. In an embodiment, the network device may be a satellite or a balloon base station. For example, the satellite may be a low earth orbit (LEO) satellite, a medium earth orbit (MEO) satellite, a geostationary earth orbit (GEO) satellite, a high elliptical orbit (HEO) satellite, or the like. In an embodiment, the network device may also be a base station deployed on land or water.

In embodiments of the disclosure, the network device serves a cell, and the terminal device communicates with the network device on a transmission resource (for example, a frequency-domain resource or a spectrum resource) for the cell. The cell may be a cell corresponding to the network device (for example, a base station). The cell may belong to a macro base station, or may belong to a base station corresponding to a small cell. The small cell may include: a metro cell, a micro cell, a pico cell, a femto cell, and the like. These small cells are characterized by small coverage and low transmission power and are adapted to provide data transmission service with high-rate.

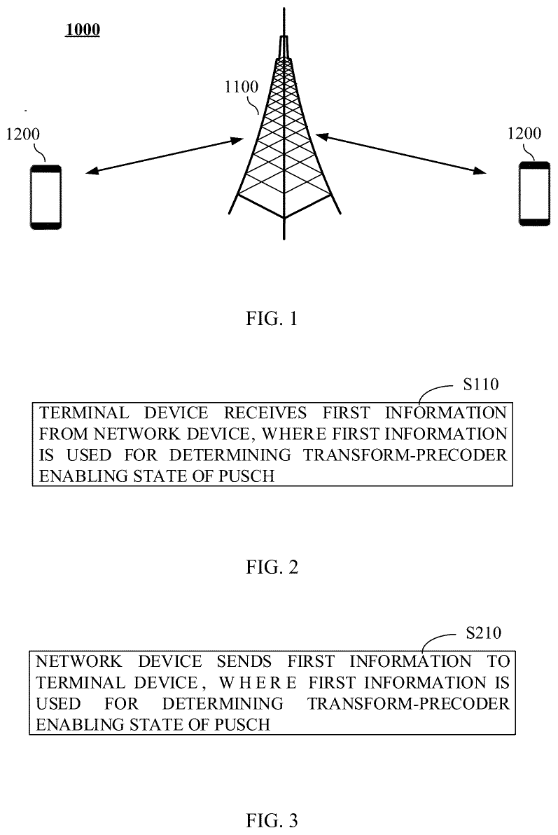

FIG. 1 exemplarily illustrates a wireless communication system 1000 including one network device 1100 and two terminal devices 1200. In an embodiment, the wireless communication system 1000 may also include multiple network devices 1100, and there can be other quantities of terminal devices in a coverage area of each of the network devices 1100.

It may be understood that, in embodiments of the disclosure, a device with communication functions in a network/system may be referred to as a “communication device”. Taking the communication system illustrated in FIG. 1 as an example, the communication device may include the network device and the terminal device(s) that have communication functions. The network device and the terminal device(s) may be the devices in embodiments of the disclosure.

It may be understood that, the terms “system” and “network” herein are usually used interchangeably throughout this disclosure. The term “and/or” herein only describes an association relationship between associated objects, which, for example, means that there can be three relationships. For example, A and/or B can mean A alone, both A and B exist, and B alone. In addition, the character “/” herein generally indicates that the associated objects are in an “or” relationship.

It may be understood that, “indication” referred to in embodiments of the disclosure may be a direct indication, may be an indirect indication, or may mean that there is an association relationship. For example, A indicates B may mean that A directly indicates B, for instance, B can be obtained according to A; may mean that A indirectly indicates B, for instance, A indicates C, and B can be obtained according to C; or may mean that there is an association relationship between A and B.

In the elaboration of embodiments of the disclosure, the term “correspondence” may mean that there is a direct or indirect correspondence between the two, may mean that there is an association between the two, or may mean a relationship of indicating and being indicated or configuring and being configured, etc.

For better understanding of technical solutions of embodiments of the disclosure, the related art of embodiments of the disclosure will be described below. The following related art as an optional scheme can be arbitrarily combined with the technical solutions of embodiments of the disclosure, which shall all belong to the protection scope of embodiments of the disclosure.

### (I) Uplink (UL) Data Transmission in NR

In NR technologies, physical uplink shared channel (PUSCH) transmission includes PUSCH transmission scheduled based on UL grant and PUSCH transmission based on configured grant (CG). The UL grant includes UL grant carried in downlink control information (DCI) such as DCI format 0_0 or DCI format 0_1, or UL grant carried in a random access response (RAR).

When a base station schedules the UL data transmission via the DCI carrying the UL grant, the base station may carry a TimeDomainResourceAllocation (TDRA) field in the DCI. The TDRA field has 4 bits and may indicate 16 different rows in a resource allocation table, where each of the rows contains a different resource allocation combination of, for example, a start position S, a length L, a time interval k2, and a different type of a PUSCH. In the above, k2 represents the number of offset slots between a slot where the DCI is located and a slot where the PUSCH is located. In addition, the DCI may also indicate frequency-domain resource allocation information, a modulation and coding scheme (MCS), a new data indicator (NDI), a redundancy version, a hybrid automatic repeat reQuest (HARQ) process number, and other information of the PUSCH.

In an NR system, a random access procedure uses a four-step procedure similar to a procedure in the LTE, including a procedure for sending a first-step message (Msg1), a second-step message (Msg2), a third-step message (Msg3), and a fourth-step message (Msg4). The Msg3 is carried in the PUSCH, and UL grant of a PUSCH for initial transmission of the Msg3 is carried in the RAR in the Msg2. As illustrated in a table below, the RAR UL grant contains time-domain and frequency-domain resource allocation information, a transmit power control (TPC) command, frequency hopping, an MCS, and the like of the PUSCH.

| RAR grant field | Number of bits |
|---|---|
| Frequency hopping flag | 1 |
| PUSCH frequency resource | 14, for operation without |
| allocation | shared spectrum channel access |
| | 12, for operation with shared |
| | spectrum channel access |
| PUSCH time resource allocation | 4 |
| MCS | 4 |
| TPC command for PUSCH | 3 |
| CSI request | 1 |
| ChannelAccess-CPext | 0, for operation without |
| | shared spectrum channel access |
| | 2, for operation with |
| | shared spectrum channel access |

If the Msg3 is not correctly received by the base station, the base station may indicate, via the DCI, scheduling information for retransmission of the Msg3. Specifically, the scheduling information is carried in DCI format 0_0 scrambled by a temporary cell radio network temporary identifier (TC-RNTI). In addition to the contents contained in the RAR UL grant, the scheduling information may further include the NDI, the redundancy version, and the HARQ process number.

### (II) Waveform for UL Transmission in NR

In the LTE, a cyclic prefix orthogonal frequency division multiplexing (CP-OFDM) waveform is supported in downlink (DL), and a discrete fourier transform-spread orthogonal frequency division multiplexing (DFT-S-OFDM) waveform is merely supported in UL. On this basis, the CP-OFDM waveform is also introduced in UL in the NR, which can support more flexible data scheduling.

That is, the NR has two options for UL waveforms: one is CP-OFDM (same as a DL waveform), and the other one is DFT-S-OFDM (same as an LTE-UL waveform). Whether a UE needs to use the CP-OFDM or the DFT-S-OFDM depends on the following radio resource control (RRC) parameters.

PUSCH-Config.transformPrecoder, which is used for configuring a waveform for a UE-specific PUSCH transmission.

RACH-ConfigCommon.msg3-transformPrecoder, which is used for configuring a waveform for PUSCH transmission of the Msg3.

ConfiguredGrantConfig.transformPrecoder, which is used for configuring a waveform for CG-PUSCH transmission.

MsgA-PUSCH-Config.msgA-TransformPrecoder-r16, which is used for configuring a waveform for PUSCH transmission of the MsgA.

### (III) PUSCH Repetitions in NR

In an NR system, in order to support an ultra-reliable and low latency communication (URLLC) service, repetition of UL data transmission is used to improve reliability of transmission. The PUSCH repetitions have two types: PUSCH repetition Type A and PUSCH repetition Type B. A PUSCH repetition type is indicated and determined by a higher-layer signaling. For the PUSCH repetition Type A and the PUSCH repetition Type B, time-domain resource allocation modes for the PUSCH are different.

PUSCH repetition Type A: a start symbol S of the PUSCH and the number L of consecutive symbols starting from the symbol S are determined by a start and length indicator value (SLIV) indicated in a physical downlink control channel (PDCCH).

PUSCH repetition Type B: the start symbol S of the PUSCH is determined by start symbol (startSymbol) information corresponding to a row in a time-domain resource allocation table, and the number L of consecutive symbols starting from the symbol S is determined by length information corresponding to the row in the time-domain resource allocation table.

TDRA information PUSCH-TimeDomainResource AllocationList-r16 that is introduced in release 16 (R16) to support the PUSCH repetitions contains a symbol where the PUSCH is located, and numberOfRepetitions indicates the number K of PUSCH repetitions. The UE determines, according to the TDRA information and the PUSCH repetition type determined by the higher-layer signaling, a time-domain resource where the PUSCH repetitions are located.

For the PUSCH repetition Type A, the UE repeats the same transmission block in K consecutive slots. Symbol allocation in each slot is the same, i.e., symbol allocation in a slot indicated by startSymbolAndLength.

In the related art, normal PUSCH repetitions and Msg3-PUSCH repetitions are introduced to improve coverage. For the Msg3-PUSCH repetitions, some of 4 bits of an MCS information field in the RAR UL grant indicate the number of repetitions. For the normal PUSCH repetitions, some bits in an MCS information field in the DCI format 0_0 scrambled by the TC-RNTI indicate the number of repetitions.

Specifically, 4 bits of the MCS information field in the RAR UL grant may indicate the first 16 MCS indexes in an MCS table below.

| | Modulation | | |
|---|---|---|---|
| MCS Index | Order | Target code Rate | Spectral |
| I_{MCS} | Qₘ | R × 1024 | efficiency |
| 0 | q | 240/q | 0.2344 |
| 1 | q | 314/q | 0.3066 |
| 2 | 2 | 193 | 0.3770 |
| 3 | 2 | 251 | 0.4902 |
| 4 | 2 | 308 | 0.6016 |
| 5 | 2 | 379 | 0.7402 |
| 6 | 2 | 449 | 0.8770 |
| 7 | 2 | 526 | 1.0273 |
| 8 | 2 | 602 | 1.1758 |
| 9 | 2 | 679 | 1.3262 |
| 10 | 4 | 340 | 1.3281 |
| 11 | 4 | 378 | 1.4766 |
| 12 | 4 | 434 | 1.6953 |
| 13 | 4 | 490 | 1.9141 |
| 14 | 4 | 553 | 2.1602 |
| 15 | 4 | 616 | 2.4063 |
| 16 | 4 | 658 | 2.5703 |
| 17 | 6 | 466 | 2.7305 |
| 18 | 6 | 517 | 3.0293 |
| 19 | 6 | 567 | 3.3223 |
| 20 | 6 | 616 | 3.6094 |
| 21 | 6 | 666 | 3.9023 |
| 22 | 6 | 719 | 4.2129 |
| 23 | 6 | 772 | 4.5234 |
| 24 | 6 | 822 | 4.8164 |
| 25 | 6 | 873 | 5.1152 |
| 26 | 6 | 910 | 5.3320 |
| 27 | 6 | 948 | 5.5547 |

| | | |
|---|---|---|
| 28 | q | reserved |
| 29 | 2 | reserved |
| 30 | 4 | reserved |
| 31 | 6 | reserved |

Due to limited choices of a size of the Msg3, and due to limited MCS levels used for Msg3-PUSCH transmission since the Msg3-PUSCH repetitions are applied in coverage-enhancement scenarios, the Msg3-PUSCH repetitions can be reduced. For example, the most significant 2 bits in a 4-bit MCS information field may indicate four numbers of repetitions, while the least significant 2 bits in an original MCS information field may indicate an MCS index and may indicate four MCS indexes in this case.

As described above, different UL waveforms can be supported in a communication system. In the related art, the UL waveform may be implemented by enabling and disabling a transform precoder configured semi-statically through an RRC signaling. Enabling the transform precoder corresponds to the DFT-S-OFDM waveform, and disabling the transform precoder corresponds to the CP-OFDM waveform. The DFT-S-OFDM waveform has a relatively low peak to average power ratio (PAPR), which can achieve better coverage and can be applied in scenarios with limited coverage. The CP-OFDM waveform can support more flexible data scheduling, which may be often applied in scenarios with unlimited coverage. In order to improve coverage of the PUSCH, how to switch the UL waveform more flexibly needs to be taken into consideration.

The solutions provided in embodiments of the disclosure are mainly used to solve at least one of the above problems.

For better understanding of the features and technical contents of embodiments of the disclosure, the implementation of the embodiments of the disclosure will be described in detail below with reference to the accompanying drawings. The accompanying drawings herein are merely intended for illustration rather than limitation of embodiments of the disclosure.

FIG. 2 is a schematic flowchart of a method for information processing according to an embodiment of the disclosure. In an embodiment, the method is applicable to the system illustrated in FIG. 1, but is not limited thereto. The method includes the following.

At S110, a terminal device receives first information from a network device. The first information is used for determining a transform-precoder enabling state of a PUSCH.

Exemplarily, the first information may include indication information delivered by the network device, or a DL signal used for obtaining measurement information. For example, the DL signal may be various reference signals such as a synchronization signal block (SSB) and a channel state information-reference signal (CSI-RS). On this basis, the terminal device may determine the transform-precoder enabling state of the PUSCH according to an indication from the network device. Alternatively, the terminal device may determine the transform-precoder enabling state of the PUSCH based on a measurement result by measuring the DL signal.

Exemplarily, the transform-precoder enabling state of the PUSCH may include a first enabling state or a second enabling state. The first enabling state may be enabled, and the second enabling state may be disabled. Alternatively, the first enabling state may be disabled, and the second enabling state may be enabled. Since different transform-precoder enabling states, such as enabled or disabled, may correspond to different UL waveforms, the terminal device can switch the UL waveform dynamically by determining the transform-precoder enabling state dynamically, thereby improving coverage of the PUSCH.

Corresponding to the above method, FIG. 3 illustrates a schematic flowchart of a method for information processing according to another embodiment of the disclosure. In an embodiment, the method is applicable to the system illustrated in FIG. 1, but is not limited thereto. The method includes the following.

At S210, a network device sends first information to a terminal device. The first information is used for determining a transform-precoder enabling state of a PUSCH.

As described above, in some embodiments, the first information may include indication information of the transform-precoder enabling state (i.e., information for indicating an enabling state of a transform precoder). That is, the network device may determine and indicate to the terminal device whether to enable a UL transform precoder. In different PUSCH transmission scenarios, indication manners may be different, and some examples are provided below.

### Example 1: The Indication Information is Carried in First DCI

In an embodiment, the first DCI in this example includes at least one of: DCI for scheduling PUSCH transmission; first common DCI; or first group common DCI.

An optional manner is that the first DCI carrying the indication information includes the DCI for scheduling the PUSCH transmission. Specifically, during dynamic UL scheduling, the network device (for example, a base station) may determine, based on actual situations, whether to enable the UL transform precoder. For example, whether a transform precoder is used for a scheduled PUSCH may be determined according to at least one of a received signal-to-noise ratio of the PUSCH or a demodulation reference signal (DMRS), a bit error rate (BER) of the PUSCH, a measurement result of a sounding reference signal (SRS), or a result of a power headroom report (PHR). Then, the indication information of the transform-precoder enabling state may be carried in the DCI for scheduling the PUSCH transmission.

Exemplarily, the DCI for scheduling the PUSCH transmission may be, for example, DCI format 0_0 or DCI format 0_1. Specifically, the DCI for scheduling the PUSCH transmission may contain UL grant, and may further contain the indication information of the transform-precoder enabling state. The indication information may be 1-bit information. Exemplarily, if the indication information of the transform-precoder enabling state is configured in DCI by the network device, the DCI may contain a 1-bit information field. The information field indicates that the transform-precoder is to be enabled or disabled. For example, if a value of the information field is 0, it indicates that the transform-precoder is to be disabled. If the value of the information field is 1, it indicates that the transform-precoder is to be enabled. If the indication information of the transform-precoder enabling state is not configured by the network device, a size of the information field in the DCI is 0, that is, the DCI does not contain the information field.

Another optional manner is that the first DCI includes the first common DCI or the first group common DCI.

In an embodiment, in this example, the above method for information processing may further include the following. The terminal device determines a transform-precoder enabling state of the PUSCH that is after a first time interval based on a transform-precoder enabling state indicated by the first DCI.

That is, the transform-precoder enabling state indicated by the first DCI starts to be valid after the first time interval. Specifically, since the terminal device requires some processing time to switch a UL-transform-precoder enabling state, a certain time interval needs to be reached between time when the first DCI is received and validity-start time for the transform-precoder enabling state indicated by the first DCI.

Exemplarily, in case where the transform-precoder enabling state indicated by the first DCI is different from a transform-precoder enabling state of the PUSCH prior to reception of the first DCI (that is, the transform-precoder enabling state changes), the terminal device may determine a transform-precoder enabling state of the PUSCH that is after a certain time interval based on an indication of the first DCI. For example, if the UL-transform-precoder enabling state prior to reception of the first DCI is enabled and the transform-precoder enabling state indicated by the first DCI is disabled, or if the UL-transform-precoder enabling state prior to reception of the first DCI is disabled and the transform-precoder enabling state indicated by the first DCI is enabled, then the transform-precoder enabling state of the PUSCH that is after the first time interval may be determined according to the indication of the first DCI.

In an embodiment, a duration for the first time interval may be determined based on capability of the terminal device. For example, the duration for the first time interval may be determined based on time for processing a PDCCH by the terminal device (for example, decoding time) and PUSCH-related time. The PUSCH-related time may include preparation time of the PUSCH, where the preparation time may include encoding time of the PUSCH and switching time of the transform-precoder enabling state. Alternatively, the PUSCH-related time may include the preparation time of the PUSCH and the switching time of the transform-precoder enabling state, where the preparation time may include the encoding time of the PUSCH. Exemplarily, the duration for the first time interval is greater than or equal to a sum of the time for processing the PDCCH and the above PUSCH-related time.

Exemplarily, the first time interval may be pre-defined or configured/indicated by the network device. For example, the first time interval may be pre-defined according to the capability of the terminal device, where the capability includes capability for the terminal device to switch the transform-precoder enabling state, such as switching time required for the terminal device. For another example, the first time interval may be configured by the network device through a higher-layer signaling (for example, an RRC signaling), and the first time interval may also be indicated by the network device in the first DCI or other DCI.

In an embodiment, when the first DCI includes DCI for scheduling the PUSCH, the terminal device may determine transmission time of the PUSCH based on time when the DCI is received and the first time interval. In this way, the scheduled PUSCH can use a waveform corresponding to the transform-precoder enabling state indicated by the DCI.

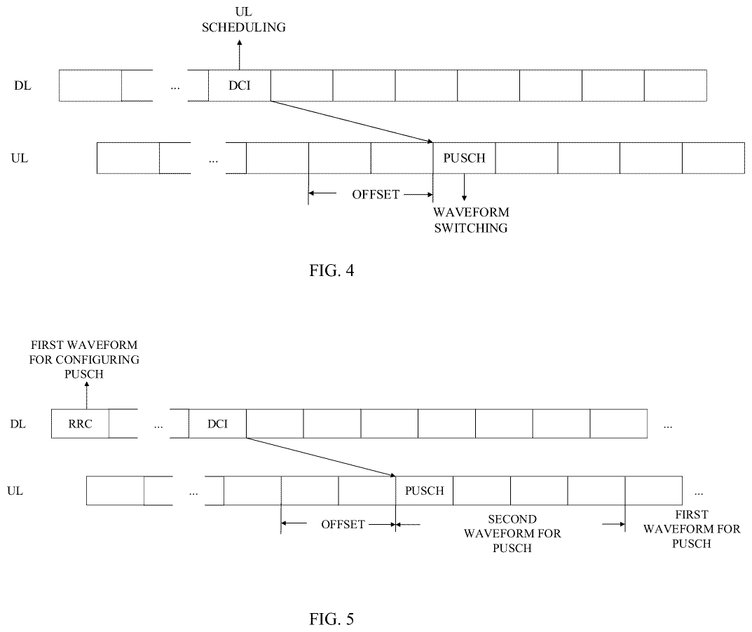

For example, the terminal device may perform offset based on the time when the DCI is received, so as to obtain the transmission time of the PUSCH, where the offset is the first time interval. As illustrated in FIG. 4, after DCI carrying UL scheduling information indicates the transform-precoder enabling state of the PUSCH, the terminal device completes waveform switching after an offset of a time interval and transmits the PUSCH by using a switched waveform.

For another example, for the DCI carrying the UL scheduling information, the DCI may indicate via a parameter k2 a time interval between the DCI and the PUSCH. The terminal device may determine the transmission time of the PUSCH based on the time when the first DCI is received, the first time interval related to switching of the transform-precoder enabling state, and the parameter k2. For example, the terminal device may perform offset based on the time when the first DCI is received, so as to obtain the transmission time of the PUSCH, where the offset may be a maximum value of the first time interval and k2 or may be a sum of the first time interval and k2.

In an embodiment, in case where the transform-precoder enabling state does not change, a time interval between the DCI and the PUSCH may not be limited by the first time interval.

In an embodiment, in this example, the indication information of the transform-precoder enabling state may specifically indicate a transform-precoder enabling state of the PUSCH that is within a first time range. The first time range may be a time range corresponding to a preset validity duration. That is, the transform-precoder enabling state indicated by the first DCI is limited by a certain validity time, such as a certain duration.

For example, in case where the transform-precoder enabling state indicated by the first DCI is different from a semi-statically configured transform-precoder enabling state, the terminal device determines the transform-precoder enabling state of the PUSCH that is within the first time range based on the enabling state indicated by the first DCI. After the first time range, another transform-precoder enabling state may be switched to. The semi-statically configured transform-precoder enabling state may be configured through the higher-layer signaling, for example, the RRC signaling.

In an embodiment, in case where the first time interval is pre-defined or configured by the network, the indication information of the transform-precoder enabling state carried in the first DCI indicates a transform-precoder enabling state of the PUSCH that is within a first time range after the first time interval.

In an embodiment, the above method for information processing may further include the following. In case where the transform-precoder enabling state indicated by the first DCI is different from the semi-statically configured transform-precoder enabling state, the terminal device may determine a transform-precoder enabling state of the PUSCH that is after the first time range based on the semi-statically configured transform-precoder enabling state.

The above validity time for the transform-precoder enabling state of the PUSCH may be controlled through a timer. For example, when the transform-precoder enabling state indicated by the DCI is different from the semi-statically configured transform-precoder enabling state, the timer is started, where a timing duration is a duration for the first time range. When the timer expires, the semi-statically configured transform-precoder enabling state is switched back to. When the transform-precoder enabling state indicated by the received DCI is different from the semi-statically configured transform-precoder enabling state during running of the timer, the timer is restarted.

As illustrated in FIG. 5, a first waveform for the PUSCH is configured through the RRC signaling, the DCI indicates that the PUSCH is to be switched to a second waveform, and after a period of time, a waveform for the PUSCH is switched back to the first waveform configured through the RRC signaling.

### Example 2: The Indication Information is Carried in a Msg2 in a Random Access Procedure

In an embodiment, the indication information is carried in RAR UL grant in the Msg2.

In an embodiment, the indication information is used for determining a transform-precoder enabling state of the PUSCH for a Msg3 in the random access procedure. Correspondingly, the above method for information processing may further include the following. The terminal device determines the transform-precoder enabling state of the PUSCH for the Msg3 in the random access procedure based on the transform-precoder enabling state indicated by the Msg2.

Initial Msg3-PUSCH transmission in the four-step random access procedure is scheduled by the RAR UL grant in the Msg2. For the Msg3-PUSCH transmission, the network device, such as the base station, may determine, based on actual situations, whether to enable a transform precoder of the Msg3 PUSCH. To this end, the network device may indicate via the Msg2 the transform-precoder enabling state of the Msg3 PUSCH.

Exemplarily, the transform-precoder enabling state of the Msg3 PUSCH may be indicated via the following information fields in the RAR UL grant.

1. A newly-added information field, for example, an information field dedicated to indicating the transform-precoder enabling state.

2. An information field for a CSI request.

In some related art, although the information field for the CSI request in the RAR UL grant exists, the information field is substantially not used for requesting CSI. Therefore, the information field may indicate the transform-precoder enabling state.

3. An information field for PUSCH frequency resource allocation.

For example, the information field for PUSCH frequency resource allocation in the RAR grant in the related art is used for frequency resource allocation. The information field contains 14 bits, which may be used for UL resource allocation in a bandwidth part (BWP) containing up to 180 physical resource blocks (PRBs) (determined based on NR resource allocation type 1) for the Msg3-PUSCH transmission. The number of bits in the information field can be reduced at the cost of some flexibility in frequency-domain allocation, for example, 1 bit thereof may be reused to indicate the transform-precoder enabling state.

4. A TDRA information field.

Time-domain resource allocation information represented by TDRA information in the RAR UL grant is indicated by a time-domain allocation list (pusch-TimeDomainAllocationList) in common configuration information (pusch-ConfigCommon information) configured by the network device. When the pusch-ConfigCommon information does not contain the pusch-TimeDomainAllocationList information, a value of the TDRA information in the RAR UL grant corresponds to TDRA information in a default PUSCH TDRA table. That is, 4 bits of the TDRA information field indicate one of 16 pieces of TDRA information in the TDRA table. In order to support the indication of the transform-precoder enabling state of the Msg3 PUSCH, the transform-precoder enabling state corresponding to each piece of TDRA information in the PUSCH TDRA list information in the pusch-ConfigCommon information may be configured, or the transform-precoder enabling state corresponding to each piece of TDRA information in a default PUSCH time-domain resource allocation A table may be defined. The network device also indicates the transform-precoder enabling state corresponding to the TDRA information while indicating the TDRA information.

5. An MCS information field.

Due to limited choices of a size of the Msg3, and due to limited MCS levels used for Msg3-PUSCH transmission since the Msg3-PUSCH repetitions are applied in coverage-enhancement scenarios, the Msg3-PUSCH repetitions can be reduced on an existing basis. For example, the most significant 1 bit in a 4-bit MCS information field may indicate the transform-precoder enabling state, while the least significant 3 bits in an original MCS information field may indicate an MCS index.

6. A TPC command information field.

The number of bits in the information field can be reduced at the cost of a certain indication range of a TPC command, for example, 1 bit thereof may be reused to indicate the transform-precoder enabling state.

In an embodiment, the above PUSCH for the Msg3 is a PUSCH for initial transmission. That is, the terminal device may determine a transform-precoder enabling state of the PUSCH for initial transmission of the Msg3 based on the transform-precoder enabling state indicated by the Msg2.

In an embodiment, a transform-precoder enabling state of the PUSCH for retransmission of the Msg3 is determined based on an indication of DCI. For example, the DCI is DCI for scheduling the retransmission of the Msg3. For example, the retransmission of the Msg3 may be scheduled by DCI format 0_0 scrambled by a TC-RNTI, and the transform-precoder enabling state or a waveform used for the retransmission of the Msg3 may be indicated by the DCI format 0_0 scrambled by the TC-RNTI.

### Example 3: The Indication Information is Carried in a Medium Access Control (MAC) Control Element (CE)

The transform-precoder enabling state of the PUSCH is indicated by the MAC CE. That is, the transform-precoder enabling state of the PUSCH is not determined by scheduling DCI, and may be controlled by the MAC CE. Since the MAC CE is carried in a data channel, an HARQ mechanism can ensure reliable reception of the indication information in the MAC CE.

In an embodiment, the indication information is used for determining a transform-precoder enabling state of the PUSCH that is after a second time interval. Correspondingly, the above method for information processing may further include the following. The terminal device determines the transform-precoder enabling state of the PUSCH that is after the second time interval based on the transform-precoder enabling state indicated by the MAC CE.

Exemplarily, the second time interval may be pre-defined or configured/indicated by the network device. For example, the second time interval may be pre-defined according to the capability of the terminal device, where the capability includes capability for the UE to switch the transform-precoder enabling state, such as switching time required for the UE. For another example, the second time interval may be configured by the network device through the higher-layer signaling (for example, the RRC signaling), and the second time interval may also be indicated by the network device in the DCI.

Specifically, after receiving the MAC CE carrying the indication information of the transform-precoder enabling state, the UE validates the indicated transform-precoder enabling state after a certain time interval. For example, after receiving the MAC CE, the UE starts a timer, and upon expiration of the timer, the UE validates the transform-precoder enabling state indicated by the MAC CE. A duration of the timer, i.e., the second time interval, may be pre-defined or configured by the network. During running of the timer, the UE may complete the switching of the transform-precoder enabling state of the PUSCH.

### Example 4: The Indication Information is Carried in Configuration Information of a CG Resource

A basic idea of CG transmission technology is that the network device pre-allocates an UL transmission resource to the terminal device and the terminal device may initiate UL transmission directly on the pre-allocated resource according to service requirements. There are two types of CG resource configuration modes, namely, a type-1 CG resource configuration mode and a type-2 CG resource configuration mode.

Type-1 CG resource configuration mode: specific resource configuration information required for transmission on the CG resource (information different from dynamic UL transmission or information specific to CG transmission) is configured through the higher-layer signaling. In the type-1 CG resource configuration mode, once configuration of the higher-layer signaling is completed, the CG resource is activated.

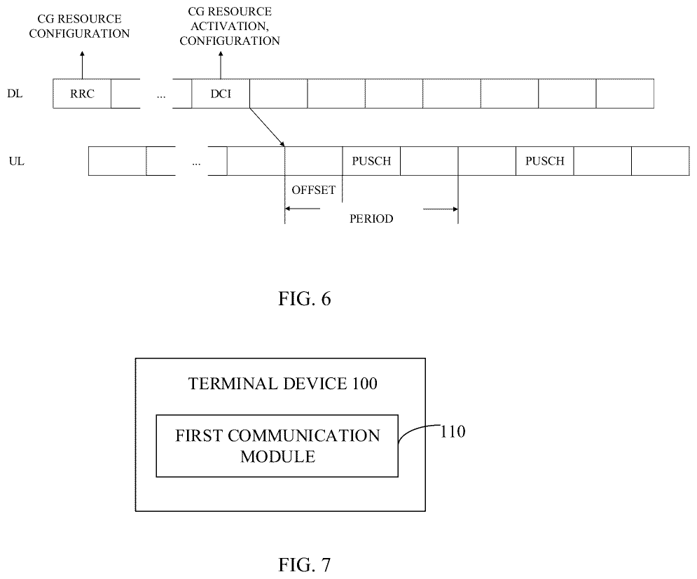

Type-2 CG resource configuration mode: a part of specific resource configuration information required for transmission on the CG resource is configured through the higher-layer signaling, and the rest of specific resource configuration information is activated and configured through the DCI. As illustrated in FIG. 6, a time offset, an MCS, a DMRS configuration, and other information of a CG-PUSCH resource are activated and indicated through the DCI.

Based on the transform-precoder enabling state for CG-PUSCH transmission, semi-static configuration may be performed by transform-precoder configuration grant information (ConfiguredGrantConfig.transformPrecoder parameter). In order to change the transform-precoder enabling state dynamically, the transform-precoder enabling state may be carried based on the configuration information of the CG resource.

In an embodiment, the configuration information of the CG resource carrying the indication information includes at least one of: activation DCI of the CG resource; second common DCI; second group common DCI.

For example, for the type-2 CG resource configuration mode, the transform-precoder enabling state used for CG-PUSCH transmission to-be-activated may be indicated by the activation DCI.

For another example, the type-1 and the type-2 may further be indicated by additional DCI, for example, the second common DCI or the second group common DCI, carried in a PDCCH.

By using the above examples 1 to 4, in different PUSCH transmission scenarios, the network device may determine the transform-precoder enabling state of the PUSCH according to actual situations, and the terminal device may determine the enabling state according to the indication information delivered by the network device. In this way, the transform-precoder enabling state can be dynamically indicated by the network in different PUSCH transmission scenarios.

In an embodiment, in embodiments of the disclosure, the transform-precoder enabling state remains unchanged during PUSCH repetitions.

Specifically, in a scenario of PUSCH repetitions, including dynamically-scheduled-PUSCH repetitions, CG-PUSCH repetitions, and Msg3-PUSCH repetitions, the UE validates the indicated transform-precoder enabling state prior to the PUSCH repetitions, and the UE does not change the transform-precoder enabling state during the PUSCH repetitions. That is, the UE does not expect or validate an indication that is received during the PUSCH repetitions to change the transform-precoder enabling state. For example, if the first information, such as the first DCI, is received during the PUSCH repetitions, the terminal device may not determine the transform-precoder enabling state of the PUSCH based on the first information (or, the terminal device may not validate the transform-precoder enabling state indicated by the first information). If time when the first information is received is not during the PUSCH repetitions, the terminal device may determine the transform-precoder enabling state of the PUSCH based on the first information.

As described above, in some embodiments, the first information may include a first DL signal, and the first DL signal is used for obtaining measurement information. That is, the terminal device may determine, based on the DL signal, whether to enable the UL transform precoder.

In an embodiment, the above method for information processing may further include the following. The terminal device obtains the measurement information based on the DL signal, and determines the transform-precoder enabling state of the PUSCH based on the measurement information and a first threshold.

For example, the UE determines the transform-precoder enabling state of the PUSCH based on a measurement result of the DL signal. The measurement result of the DL signal reflects coverage conditions. When it is determined based on the measurement result that a certain coverage such as a cell center is reached, the UE may determine to use a CP-OFDM waveform. If the UE is at the edge of a cell where the coverage is relatively poor, the UE may determine to use a DEF-S-OFDM. Whether the coverage is reached may be determined based on the measurement result and the first threshold. For example, if a measurement value is greater than the first threshold, it is determined that the coverage is reached, and the CP-OFDM is used.

In an embodiment, the first threshold may be pre-defined or configured by the network device.

In an embodiment, the first DL signal may include an SSB, a CSI-RS, and the like.

In an embodiment, after determining the transform-precoder enabling state, the terminal device may further inform the network device of the transform-precoder enabling state. That is, the above method for information processing may further include the following. The terminal device sends second information to the network device, where the second information indicates the transform-precoder enabling state of the PUSCH.

Correspondingly, the above method for information processing may further include the following. The network device receives the second information from the terminal device, where the second information indicates the transform-precoder enabling state of the PUSCH.

In an embodiment, the terminal device may also not inform the network device of the enabling state, and the network device receives the PUSCH by blindly detecting the UL waveform.

In an embodiment, embodiments of the disclosure further provide a manner in which the terminal device indicates to the network device the transform-precoder enabling state during initial access. That is, during initial access, in addition to being configured by the network, a waveform used for an MsgA/Msg3 PUSCH of the terminal device may also be determined flexibly in the above method according to actual situations, for example, measurement information of the first DL signal.

Specifically, the terminal device may indicate via a physical random access channel (PRACH) whether the MsgA/Msg3 PUSCH uses the transform precoder. That is, the above second information may include a PRACH, and the PRACH indicates a transform-precoder enabling state of a PUSCH for MsgA or Msg3 in the random access procedure.

Exemplarily, the second information may be carried in the PRACH. Alternatively, the transform-precoder enabling state of the PUSCH for the MsgA or Msg3 may be indicated by a resource of the PRACH. For example, the resource of the PRACH corresponds to the transform-precoder enabling state of the PUSCH, and different PRACHs correspond to requesting different waveforms for the MsgA/Msg3 PUSCH, that is, correspond to different transform-precoder enabling states. When the terminal device transmits the PRACH on a certain resource of the PRACH, the terminal device indicates to request the corresponding transform-precoder enabling state.

In an embodiment, the resource of the PRACH may include a PRACH occasion or a different preamble.

In an embodiment, embodiments of the disclosure further provide a manner in which the terminal device indicates to the network device the transform-precoder enabling state in a CG-PUSCH transmission scenario. Exemplarily, the above method for information processing may further include the following. The terminal device determines a CG resource configuration of the PUSCH in at least one CG resource configuration based on the transform-precoder enabling state of the PUSCH, where the transform-precoder enabling state of the PUSCH corresponds to the CG resource configuration.

Specifically, each of the at least one CG resource configuration configured/activated by the network device corresponds to one transform-precoder enabling state. That is, different transform-precoder enabling states may correspond to different CG transmission resource configurations, so that CG transmission resources can match with transmission waveforms. Exemplarily, in case where the terminal device determines the transform-precoder enabling state of the PUSCH based on the measurement information of the first DL signal, the terminal device can select a corresponding CG resource configuration based on the transform-precoder enabling state of the PUSCH.

The specific setting and implementation of embodiments of the disclosure are described above from different perspectives through the multiple embodiments. With the above at least one embodiment, the terminal device can determine the transform-precoder enabling state based on the first information sent by the network device. Since different transform-precoder enabling states correspond to different UL waveforms, the UL waveforms can be switched dynamically, which is conducive to improving UL coverage.

Corresponding to the processing method described above in the at least one embodiment, a terminal device 100 is further provided in embodiments of the disclosure. As illustrated in FIG. 7, the terminal device 100 includes a first communication module 110. The first communication module 110 is configured to receive first information from a network device, where the first information is used for determining a transform-precoder enabling state of a PUSCH.

In an embodiment, in embodiments of the disclosure, the first information includes indication information of the transform-precoder enabling state.

In an embodiment, in embodiments of the disclosure, the indication information is carried in first DCI.

Exemplarily, in embodiments of the disclosure, the first DCI includes at least one of: DCI for scheduling PUSCH transmission; first common DCI; or first group common DCI.

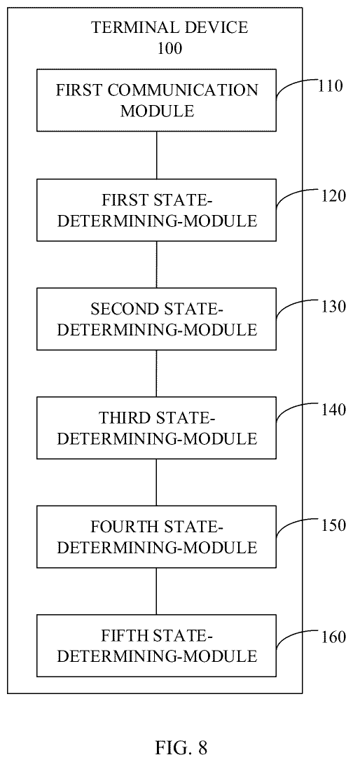

In an embodiment, in embodiments of the disclosure, as illustrated in FIG. 8, the terminal device 100 further includes a first state-determining-module 120. The first state-determining-module 120 is configured to determine a transform-precoder enabling state of the PUSCH that is after a first time interval based on a transform-precoder enabling state indicated by the first DCI.

Exemplarily, the above indication information indicates a transform-precoder enabling state of the PUSCH that is within a first time range.

In an embodiment, in embodiments of the disclosure, as illustrated in FIG. 8, the terminal device 100 further includes a second state-determining-module 130. The second state-determining-module 130 is configured to determine a transform-precoder enabling state of the PUSCH that is after the first time range based on a semi-statically configured transform-precoder enabling state, when the transform-precoder enabling state indicated by the first DCI is different from the semi-statically configured transform-precoder enabling state.

Exemplarily, the indication information is carried in a Msg2 in a random access procedure.

In an embodiment, the indication information is carried in RAR UL grant in the Msg2.

In an embodiment, in embodiments of the disclosure, as illustrated in FIG. 8, the terminal device 100 further includes a third state-determining-module 140. The third state-determining-module 140 is configured to determine a transform-precoder enabling state of the PUSCH for a Msg3 in the random access procedure based on the transform-precoder enabling state indicated by the Msg2.

Exemplarily, the indication information is carried in an MAC CE.

In an embodiment, in embodiments of the disclosure, as illustrated in FIG. 8, the terminal device 100 further includes a fourth state-determining-module 150. The fourth state-determining-module 150 is configured to determine a transform-precoder enabling state of the PUSCH that is after a second time interval based on the transform-precoder enabling state indicated by the MAC CE.

Exemplarily, the indication information is carried in configuration information of a CG resource.

In an embodiment, in embodiments of the disclosure, the configuration information of the CG resource includes at least one of: activation DCI of the CG resource; second common DCI; or second group common DCI.

Exemplarily, the transform-precoder enabling state remains unchanged during PUSCH repetitions.

In an embodiment, the first information includes a first DL signal, and the first DL signal is used for obtaining measurement information.

In an embodiment, in embodiments of the disclosure, as illustrated in FIG. 8, the terminal device 100 further includes a fifth state-determining-module 160. The fifth state-determining-module 160 is configured to obtain the measurement information based on the DL signal and determine the transform-precoder enabling state of the PUSCH based on the measurement information and a first threshold.

Exemplarily, the first communication module 110 is further configured to send second information to the network device. The second information indicates the transform-precoder enabling state of the PUSCH.

In an embodiment, the second information includes a PRACH, and the PRACH indicates a transform-precoder enabling state of the PUSCH for MsgA or Msg3 in a random access procedure.

Exemplarily, a resource of the PRACH corresponds to the transform-precoder enabling state of the PUSCH.

In an embodiment, in embodiments of the disclosure, as illustrated in FIG. 8, the terminal device 100 further includes a resource determining module 170. The resource determining module 170 is configured to determine a CG resource configuration of the PUSCH in at least one CG resource configuration based on the transform-precoder enabling state of the PUSCH. The transform-precoder enabling state of the PUSCH corresponds to the CG resource configuration.

The terminal device 100 in embodiments of the disclosure can implement corresponding functions of the terminal device in the foregoing method embodiments. For the procedure, function, implementation, and advantage corresponding to each module (sub-module, unit, or assembly, etc.) in the terminal device 100, reference can be made to the corresponding illustrations in the foregoing method embodiments, which will not be repeated herein. It may be noted that, the functions of various modules (sub-modules, units, or assemblies, etc.) in the terminal device 100 described in embodiments of the disclosure may be implemented by different modules (sub-modules, units, or assemblies, etc.), or may be implemented by the same module (sub-module, unit, or assembly, etc.). For example, the first state-determining-module and the second state-determining-module may be different modules or may be the same module, both of which can implement the corresponding functions thereof in embodiments of the disclosure. In addition, the communication module in embodiments of the disclosure may be implemented by a transceiver of a device, and some or all of the other modules may be implemented by a processor of the device.

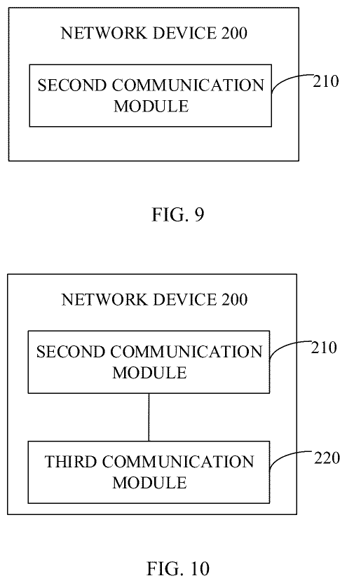

FIG. 9 is a schematic block diagram of a network device 200 according to an embodiment of the disclosure. The network device 200 may include a second communication 210. The second communication 210 is configured to send first information to a terminal device, where the first information is used for determining a transform-precoder enabling state of a PUSCH.

In an embodiment, in embodiments of the disclosure, the first information includes indication information of the transform-precoder enabling state.

Exemplarily, the indication information is carried in first DCI.

In an embodiment, the first DCI includes at least one of: DCI for scheduling PUSCH transmission; first common DCI; or first group common DCI.

In an embodiment, in embodiments of the disclosure, the indication information is carried in a Msg2 in a random access procedure.

In an embodiment, the indication information is carried in RAR UL grant in the Msg2.

In an embodiment, the indication information is used for determining a transform-precoder enabling state of the PUSCH for a Msg3 in the random access procedure.

Exemplarily, the indication information is carried in an MAC CE.

In an embodiment, the indication information is used for determining a transform-precoder enabling state of the PUSCH that is after a second time interval.

In an embodiment, the indication information is carried in configuration information of a CG resource.

In an embodiment, the configuration information of the CG resource includes at least one of: activation DCI of the CG resource; second common DCI; or second group common DCI.

In an embodiment, the first information includes a first DL signal, and the first DL signal is used for obtaining measurement information.

In an embodiment, in embodiments of the disclosure, as illustrated in FIG. 10, the network device 200 further includes a third communication module 220. The third communication module 220 is configured to receive second information from the terminal device. The second information indicates the transform-precoder enabling state of the PUSCH.

In an embodiment, the second information includes a PRACH, and the PRACH indicates a transform-precoder enabling state of the PUSCH for MsgA or Msg3 in a random access procedure.

In an embodiment, a resource of the PRACH corresponds to the transform-precoder enabling state of the PUSCH.

The network device 200 in embodiments of the disclosure can implement corresponding functions of the network device in the foregoing method embodiments. For the procedure, function, implementation, and advantage corresponding to each module (sub-module, unit, or assembly, etc.) in the network device 200, reference can be made to the corresponding illustrations in the foregoing method embodiments, which will not be repeated herein. It may be noted that, the functions of various modules (sub-modules, units, or assemblies, etc.) in the network device 200 described in embodiments of the disclosure may be implemented by different modules (sub-modules, units, or assemblies, etc.), or may be implemented by the same module (sub-module, unit, or assembly, etc.). For example, the second communication module and the third communication module may be different modules or may be the same module, both of which can implement the corresponding functions thereof in embodiments of the disclosure. In addition, the communication module in embodiments of the disclosure may be implemented by a transceiver of a device, and some or all of the other modules may be implemented by a processor of the device.

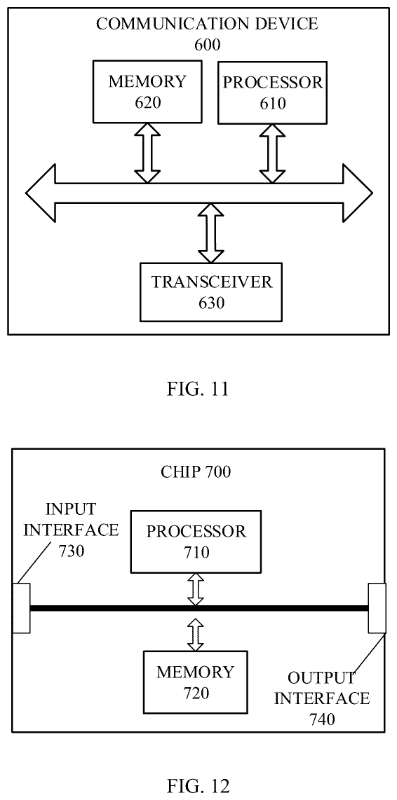

FIG. 11 is a schematic structural diagram of a communication device 600 according to an embodiment of the disclosure. The communication device 600 includes a processor 610. The processor 610 can invoke and execute a computer program stored in a memory, to implement the method in embodiments of the disclosure.

In an embodiment, the communication device 600 may further include a memory 620, where the processor 610 can invoke and execute a computer program stored in the memory 620 to implement the method in embodiments of the disclosure.

The memory 620 may be a separate device independent of the processor 610, or may be integrated into the processor 610.

In an embodiment, the communication device 600 may further include a transceiver 630. The processor 610 can control the transceiver 630 to communicate with other devices, and specifically, to send information or data to other devices or receive information or data sent by other devices.

The transceiver 630 may include a transmitter and a receiver. The transceiver 630 may further include an antenna, where one or more antennas may be provided.

In an embodiment, the communication device 600 may be a network device in embodiments of the disclosure, and the communication device 600 may implement corresponding operations implemented by the network device in various methods in embodiments of the disclosure, which will not be repeated herein for the sake of brevity.

In an embodiment, the communication device 600 may be a terminal device in embodiments of the disclosure, and the communication device 600 may implement corresponding operations implemented by the terminal device in various methods in embodiments of the disclosure, which will not be repeated herein for the sake of brevity.

FIG. 12 is a schematic structural diagram of a chip 700 according to an embodiment of the disclosure. The chip 700 includes a processor 710. The processor 710 can invoke and execute a computer program stored in a memory, so as to implement the method in embodiments of the disclosure.

In an embodiment, the chip 700 may further include a memory 720. The processor 710 can invoke and execute a computer program stored in the memory 720, so as to implement the method in embodiments of the disclosure.

The memory 720 may be a separate device independent of the processor 710, or may be integrated into the processor 710.

In an embodiment, the chip 700 may further include an input interface 730. The processor 710 can control the input interface 730 to communicate with other devices or chips, and specifically, to obtain information or data sent by other devices or chips.

In an embodiment, the chip 700 may further include an output interface 740. The processor 710 can control the output interface 740 to communicate with other devices or chips, and specifically, to output information or data to other devices or chips.

In an embodiment, the chip may be applied to the network device in embodiments of the disclosure, and the chip may implement corresponding operations implemented by the network device in various methods in embodiments of the disclosure, which will not be repeated herein for the sake of brevity.

In an embodiment, the chip may be applied to the terminal device in embodiments of the disclosure, and the chip may implement corresponding operations implemented by the terminal device in various methods in embodiments of the disclosure, which will not be repeated herein for the sake of brevity.

In an embodiment, the chip in embodiments of the disclosure may also be a system-on-chip (SOC).

The processor described above may be a general-purpose processor, a digital signal processor (DSP), a field programmable gate array (FPGA), an application specific integrated circuit (ASIC), or other programmable logic devices, transistor logic devices, discrete hardware components, or the like. The above general-purpose processor may be a microprocessor, or may also be any conventional processor or the like.

The memory described above may be a volatile memory or a non-volatile memory, or may include both the volatile memory and the non-volatile memory. The non-volatile memory may be a read-only memory (ROM), a programmable ROM (PROM), an erasable PROM (EPROM), an electrically EPROM (EEPROM), or a flash memory. The volatile memory may be a random access memory (RAM).

It may be understood that, the memory above is intended for illustration rather than limitation. For example, the memory in embodiments of the disclosure may also be a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM), a direct rambus RAM (DR RAM), and the like. In other words, the memory in embodiments of the disclosure is intended to include, but is not limited to, these and any other suitable types of memory.

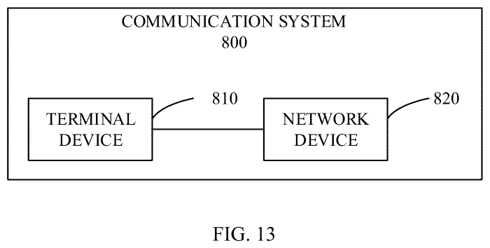

FIG. 13 is a schematic block diagram of a communication system 800 according to an embodiment of the disclosure. The communication system 800 includes a terminal device 810 and a network device 820.

The network device 820 sends first information to the terminal device 810, and the terminal device 810 receives the first information from the network device 820. The first information is used for determining a transform-precoder enabling state of a PUSCH.

The terminal device 810 may be configured to implement corresponding functions implemented by the terminal device in the methods described in various embodiments of the disclosure, and the network device 820 may be configured to implement corresponding functions implemented by the network device in the methods described in various embodiments of the disclosure, which will not be repeated herein for the sake of brevity.

All or some of the above embodiments can be implemented through software, hardware, firmware, or any other combination thereof. When implemented by software, all or some the above embodiments can be implemented in the form of a computer program product. The computer program product includes one or more computer instructions. When the computer instructions are loaded and executed on a computer, all or some the operations or functions of the embodiments of the disclosure are performed. The computer can be a general-purpose computer, a special-purpose computer, a computer network, or other programmable apparatuses. The computer instructions can be stored in a computer-readable storage medium, or transmitted from one computer-readable storage medium to another computer-readable storage medium. For example, the computer instructions can be transmitted from one website, computer, server, or data center to another website, computer, server, or data center in a wired manner or in a wireless manner. Examples of the wired manner can be a coaxial cable, an optical fiber, a digital subscriber line (DSL), and the like. The wireless manner can be, for example, infrared, wireless, microwave, or the like. The computer-readable storage medium can be any computer accessible usable-medium or a data storage device such as a server, a data center, or the like which integrates one or more usable media. The usable medium can be a magnetic medium (such as a soft disk, a hard disk, or a magnetic tape), an optical medium (such as a digital video disc (DVD)), or a semiconductor medium (such as a solid state disk (SSD)), or the like.

It may be understood that, in various embodiments of the disclosure, the magnitude of a sequence number of each of the foregoing processes does not imply an execution order, and the execution order between the processes may be determined according to function and internal logic thereof, which shall not constitute any limitation to the implementation of embodiments of the disclosure.

It will be evident to those skilled in the art that, for the sake of convenience and brevity, in terms of the specific working processes of the foregoing systems, apparatuses, and units, reference can be made to the corresponding processes in the foregoing method embodiments, which will not be repeated herein.

In the elaboration of this specification, reference terms “an embodiment”, “some embodiments”, “an example”, “a specific example”, or “some examples” means that a particular feature, structure, material, or characteristic described in connection with the embodiment or example is included in at least one embodiment or example of the disclosure. In addition, the particular feature, structure, material, or characteristic may be combined in any suitable manner in one or more embodiments or examples. Furthermore, those skilled in the art could combine different embodiments or examples and different characteristics in the embodiments or examples described in this specification without contradiction.

In addition, terms such as “first” and “second” are used only for illustration, and may not be construed as indicating or implying relativity importance or implicitly specifying the number of an indicated technical feature. Hence, a feature defined by “first” or “second” may explicitly or implicitly indicate that at least one the feature is included. In the description of the disclosure, “a plurality of” or “multiple” refers to two or more, unless otherwise definitely and specifically defined.

The foregoing elaborations are merely implementations of the disclosure, but are not intended to limit the protection scope of the disclosure. Any variation or replacement easily thought of by those skilled in the art within the technical scope disclosed in the disclosure shall belong to the protection scope of the disclosure. Therefore, the protection scope of the disclosure shall be subject to the protection scope of the claims.

What is claimed is:

1. A method for information processing, comprising:
receiving, by a terminal device, first information from a network device, wherein the first information is used for determining a transform-precoder enabling state of a physical uplink shared channel (PUSCH).

2. The method of claim 1, wherein the first information comprises indication information of the transform-precoder enabling state.

3. The method of claim 2, wherein the indication information is carried in first downlink control information (DCI).

4. The method of claim 3, wherein the first DCI comprises at least one of:
DCI for scheduling PUSCH transmission;
first common DCI; or
first group common DCI.

5. The method of claim 3, further comprising:
determining, by the terminal device, a transform-precoder enabling state of the PUSCH that is after a first time interval based on a transform-precoder enabling state indicated by the first DCI, in response to determining that the transform-precoder enabling state changes.

6. The method of claim 3, wherein the indication information indicates a transform-precoder enabling state of the PUSCH that is within a first time range.

7. The method of claim 6, further comprising:
determining, by the terminal device, a transform-precoder enabling state of the PUSCH that is after the first time range based on a semi-statically configured transform-precoder enabling state, in response to the transform-precoder enabling state indicated by the first DCI being different from the semi-statically configured transform-precoder enabling state.

8. The method of claim 2, wherein the indication information is carried in a medium access control (MAC) control element (CE).

9. The method of claim 8, further comprising:
determining, by the terminal device, a transform-precoder enabling state of the PUSCH that is after a second time interval based on the transform-precoder enabling state indicated by the MAC CE.

10. The method of claim 2, wherein the indication information is carried in configuration information of a configured grant (CG) resource; and wherein the configuration information of the CG resource comprises at least one of: activation DCI of the CG resource; second common DCI; or second group common DCI.

11. The method of claim 1, wherein the transform-precoder enabling state remains unchanged during PUSCH repetitions.

12. A method for information processing, comprising:
sending, by a network device, first information to a terminal device, wherein the first information is used for determining a transform-precoder enabling state of a physical uplink shared channel (PUSCH).

13. The method of claim 12, wherein the first information comprises indication information of the transform-precoder enabling state.

14. The method of claim 13, wherein the indication information is carried in first downlink control information (DCI).

15. The method of claim 14, wherein the first DCI comprises at least one of:
DCI for scheduling PUSCH transmission;
first common DCI; or
first group common DCI.

16. The method of claim 12, wherein the first information comprises a first downlink (DL) signal, and the first DL signal is used for obtaining measurement information.

17. The method of claim 16, further comprising:
receiving, by the network device, second information from the terminal device, wherein the second information indicates the transform-precoder enabling state of the PUSCH.

18. The method of claim 17, wherein the second information comprises a physical random access channel (PRACH), and the PRACH indicates a transform-precoder enabling state of a PUSCH for MsgA or Msg3 in a random access procedure; and wherein a resource of the PRACH corresponds to the transform-precoder enabling state of the PUSCH.

19. A terminal device, comprising:
a memory configured to store a computer program; and
a processor configured to execute the computer program stored in the memory, to:
receive first information from a network device, wherein the first information is used for determining a transform-precoder enabling state of a physical uplink shared channel (PUSCH).

20. The terminal device of claim 19, wherein the transform-precoder enabling state remains unchanged during PUSCH repetitions.
